(19) United States
(12) Patent Application Publication
(10) Pub. No.: US 2025/0292025 A1
(43) Pub. Date: Sep. 18, 2025

(54) KEY PHRASE EXTRACTION USING TEXTUAL AND EMBEDDING BASED UNSUPERVISED LEARNING WITH ENRICHED KNOWLEDGE BASE

(71) Applicant: SAP SE, Walldorf (DE)

(72) Inventors: Nibedita Dutta, Kharagpur (IN); Ayush Agrawal, Gurgaon (IN); Neha Garg, Bangalore (IN)

(21) Appl. No.: 18/665,922

(22) Filed: May 16, 2024

(30) Foreign Application Priority Data
Mar. 13, 2024 (IN) 202411018089

(51) Int. Cl. G06F 40/289; G06F 16/33; G06F 16/383

(52) U.S. Cl. CPC G06F 40/289; G06F 16/3347; G06F 16/383

(57) ABSTRACT

A plurality of candidate phrases are extracted from a first field of a received textual input. Also, first context data is extracted from a second field of the received textual input. Additionally, second context data is retrieved from one or more data sources related to the received textual input. The first context data and the second context data are combined to form combined context data. Then, the plurality of candidate phrases and the combined context data are vectorized. Next, for each candidate phrase of the plurality of candidate phrases, a similarity score is calculated between a vectorized version of the candidate phrase and a vectorized version of the combined context data. Then, a subset of candidate phrases are selected having highest calculated similarity scores. Next, the subset of candidate phrases are provided to one or more applications which are generating responses to the textual input.

### CROSS-REFERENCE TO RELATED APPLICATIONS

The present application claims priority to Indian Provisional Patent Appl. No. 202411018089 to Dutta et al., filed Mar. 13, 2024, and entitled “KEY PHRASE EXTRACTION USING TEXTUAL AND EMBEDDING BASED UNSUPERVISED LEARNING WITH ENRICHED KNOWLEDGE BASE,” and incorporates its disclosure herein by reference in its entirety.

### TECHNICAL FIELD

The present disclosure generally relates to identifying and extracting key phrases from received textual inquiries.

### BACKGROUND

Key phrases within documents have proven instrumental in expediting precise searches within extensive text collections. They have demonstrated their efficacy in enhancing a variety of natural language processing (NLP) and information retrieval (IR) tasks such as text summarization, text categorization, opinion mining, and document indexing. Likewise, the extraction of key phrases from customer support tickets can enable a variety of actions including, identification of common issues or pain points of customers, categorization and prioritization of support tickets, and analysis of emerging trends or patterns for proactive addressing of recurring issues. Additionally identified key phrases from support tickets can also help enhance searchability of an existing knowledge base thereby reducing resolution time.

A naive approach for key phrase extraction involves utilizing parts-of-speech tagging and the generation of all potential noun phrase candidates or generation of all bigrams and higher order n-grams as potential key phrases. However, this may not result in the production of optimal key phrases.

### SUMMARY

In some implementations, a plurality of candidate phrases are extracted from a first field of a received textual input by a two-stage key phrase extraction apparatus. Also, first context data is extracted from a second field of the received textual input. Additionally, second context data is retrieved from one or more data sources related to the received textual input. In another example, two textual inputs may be received by the two-stage key phrase extraction apparatus. In this example, a first textual input may be a customer ticket and a second textual input may be solution information from a knowledge base or other source. In this example, the second context data may be retrieved from the second textual input.

Next, the first context data and the second context data are combined to form combined context data. Then, the plurality of candidate phrases and the combined context data are vectorized. Next, for each candidate phrase of the plurality of candidate phrases, a similarity score is calculated between a vectorized version of the candidate phrase and a vectorized version of the combined context data. Then, a subset of candidate phrases are selected from the plurality of candidate phrases, with the subset of candidate phrases being those candidate phrases having the highest calculated similarity scores out of a plurality of calculated similarity scores corresponding to the plurality of candidate phrases. Next, the subset of candidate phrases are provided to one or more applications which are generating responses to the textual input.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates a diagram of a system, in accordance with some example implementations of the current subject matter;

FIG. 2 illustrates a logical block diagram of a two-step process for extraction of keyphrases, in accordance with some example implementations of the current subject matter;

FIG. 3 illustrates a diagram of a textual feature scoring-based method, in accordance with some example implementations of the current subject matter;

FIG. 4 illustrates an example of pseudocode for implementing the two-stage key phrase extraction methodology, in accordance with some example implementations of the current subject matter;

FIG. 5 illustrates a keyword extraction GUI, in accordance with some example implementations of the current subject matter;

FIG. 6 illustrates a keyword extraction GUI, in accordance with some example implementations of the current subject matter;

FIG. 7 illustrates an example of a process for employing a two-stage key phrase extraction methodology, in accordance with some example implementations of the current subject matter;

FIG. 8 illustrates an example of a process for employing a two-stage key phrase extraction methodology, in accordance with some example implementations of the current subject matter;

FIG. 9 illustrates an example of a process for employing textual feature scoring, in accordance with some example implementations of the current subject matter;

FIG. 10A depicts an example of a system, in accordance with some example implementations of the current subject matter; and

FIG. 10B depicts another example of a system, in accordance with some example implementations of the current subject matter.

### DETAILED DESCRIPTION

Information technology service management systems provide process and workflows that information technology (IT) teams use to provide services in a company. Incidence management, change management, and problem management are processes in these types of systems. These processes use software and tools that are used to manage and track problems, incidents, change and release level management, configuration management, and other issues.

Information technology service management systems may use ticketing software to allow organizations to resolve IT issues by streamlining the resolution process. The elements they handle, called tickets, provide context about the issues, including details, categories, and any relevant tags. A ticket is a special document or record that represents an incident, alert, request, event, or some other issue that requires attention or action from IT staff. A user or customer having a technical problem may send a ticket to the IT department for help in resolving the issue.

The extraction of key phrases from customer support tickets can have numerous benefits and enable a wide range of actions. One important advantage is the ability to identify common issues or pain points experienced by customers. By analyzing the key phrases, support teams can gain insights into the most frequent problems faced by customers, allowing them to address these issues more effectively. Another valuable application is the categorization and prioritization of support tickets. By extracting key phrases, support tickets can be automatically classified into different categories based on the identified issues. This categorization enables support teams to allocate resources efficiently and prioritize tickets based on their urgency or severity. Furthermore, the analysis of emerging trends or patterns through the identification of key phrases can help support teams proactively address recurring issues. By monitoring the key phrases extracted from support tickets over time, patterns or trends can be identified, allowing support teams to take preemptive actions to prevent similar issues from arising in the future.

The extraction of optimal keyphrases that sufficiently describe the original text is a challenge despite the presence of a plethora of algorithms for keyphrase extraction. In an example, a novel methodology is employed for keyphrase extraction from text (e.g., titles of customer tickets) based on a two stage method comprised of a candidate phrase extraction method along with a contextual features based method utilizing an enriched knowledge base. Also, a comprehensive textual feature-based scoring method may be implemented that can give better keyphrases than naïve n-gram based phrase extraction.

The evaluation of the extracted keyphrases is done against manually extracted keyphrases using two methods: “exact matching” and “approximate matching”. In exact matching, an extracted phrase that exactly matches with the manually extracted phrase is considered to be a “match” and anything that doesn't match exactly is considered a “non-match”. In approximate matching, an extracted phrase that either includes the manually extracted phrase in it or is a part of the manually extracted phrase is considered to be a “match”. The approximate matching strategy takes into consideration the non-exact matches too, providing a more comprehensive assessment of the keyphrase extraction algorithm's performance.

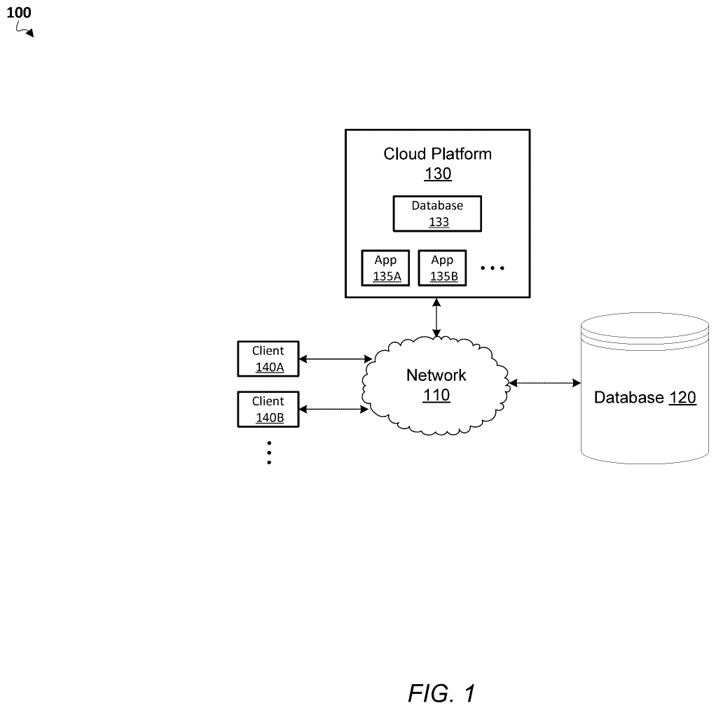

Referring now to FIG. 1, a diagram illustrating an example of a system 100 consistent with implementations of the current subject matter is depicted. In an example, the system 100 may include a cloud platform 130. The cloud platform 130 may provide resources that can be shared among a plurality of tenants. For example, the cloud platform 130 may be configured to provide a variety of services including, for example, software-as-a-service (SaaS), platform-as-a-service (PaaS), infrastructure as a service (IaaS), and/or the like, and these services can be accessed by one or more tenants of the cloud platform 130. In the example of FIG. 1, the system 100 includes a first tenant 140A (labeled client) and a second tenant 140B (labeled client as well), although system 100 may include any number of other tenants. For example, multitenancy enables multiple end-user devices (e.g., a computer including an application) as well as multiple subscribing customers having their own group of end-users with an isolated context of the particular customers to access a given cloud service having shared resources via the Internet and/or other type of network or communication link(s). Clients 140A-B may include any number of individuals and/or organizations that subscribe to cloud platform 130.

The cloud platform 130 may include resources, such as at least one computer (e.g., a server), data storage, and a network (including network equipment) that couples the computer(s) and storage. The cloud platform 130 may also include other resources, such as operating systems, hypervisors, and/or other resources, to virtualize physical resources (e.g., via virtual machines) and provide deployment (e.g., via containers) of applications (which provide services, for example, on the cloud platform, and other resources). In the case of a “public” cloud platform, the services may be provided on-demand to a client, or tenant, via the Internet. For example, the resources at the public cloud platform may be operated and/or owned by a cloud service provider (e.g., Amazon Web Services, Azure), such that the physical resources at the cloud service provider can be shared by a plurality of tenants. Alternatively, or additionally, the cloud platform 130 may be a “private” cloud platform, in which case the resources of the cloud platform 130 may be hosted on an entity's own private servers (e.g., dedicated corporate servers operated and/or owned by the entity). Alternatively, or additionally, the cloud platform 130 may be considered a “hybrid” cloud platform, which includes a combination of on-premises resources as well as resources hosted by a public or private cloud platform. For example, a hybrid cloud service may include web servers running in a public cloud while application servers and/or databases are hosted on premise (e.g., at an area controlled or operated by the entity, such as a corporate entity).

In various embodiments, the cloud platform 130 provides services to client 140A-B. Each service may be deployed via a container, which provides a package or bundle of software, libraries, and configuration data to enable the cloud platform to deploy during runtime the service to, for example, one or more virtual machines that provide the service to client 140A. The service may also include logic (e.g., instructions that provide one or more steps of a process) and an interface. The interface may be implemented as an Open Data Protocol (OData) interface (e.g., HTTP message may be used to create a query to a resource identified via a URI), although the interface may be implemented with other types of protocols including those in accordance with REST (Representational state transfer).

In the example of FIG. 1, there are two databases 133 and 120, although other quantities of databases may be implemented as well. In an example, database 120 may include a knowledge base with solution manuals providing solutions to frequently encountered user problems. Database 120 may also include other collections of data in addition to the knowledge base.

As shown in FIG. 1, the first database 133 is internal to the cloud platform 130, but the second database 120 is external to the cloud platform 130, so an external REST type call may be used to send queries and receive responses from database 120. For example, when the interface is configured in accordance with REST or the ODATA protocol, the interface may access a data model, such as the client tenant schema associated with client 140A's data at database 120. And, the interface may provide a REST or Open Data Protocol (ODATA) interface to external applications and/or services, which in this case is the database 120. In the case of REST compliant interfaces, the interface may provide a uniform interface that decouples the client and server, is stateless (e.g., a request includes all information needed to process and respond to the request), cacheable at the client side or the server side, and the like.

To illustrate further, the client 140A may cause execution of a process or job on application 135A or application 135B. Applications 135A-B are representative of any number and type of applications running on cloud platform 130. In an example, an action or a condition at client 140A may cause a message querying or requesting a response from application 135A. If the response from application 135A requires a query to the database 120 in order to obtain data associated with the query, a REST call may be made to database 120. Application 135A may receive a response to the query from the database 120. The response may be compliant with REST as well. At least a portion of the noted process may execute at the cloud platform 130 (although a portion may execute at the client 140A as well). Alternatively, or additionally, the noted process may include a service extension. The service extension may represent a modification in the process (e.g., added step(s) and/or deleted step(s)) specific to, or uniquely for, the client 140A. In other words, the service extension may customize at least a portion of the process for the client 140A.

In an example, application 135A may be a key phrase extraction application which determines key phrases based on customer tickets generated by clients 140A-B. In other examples, application 135A may be a key phrase extraction application which determines key phrases based on other types of queries (other than customer tickets) received from clients 140A-B. While the remainder of the description of FIG. 1 will be in terms of application 135A processing a customer ticket received from a client 140B, it should be understood that this is merely illustrative of one type of input that can be received. Other types of inputs (e.g., email, search query, document, social media post) may be processed in a similar manner to a customer ticket.

In an example, application 135A may implement a two-stage key phrase extraction methodology. As part of the two-stage key phrase extraction methodology, application 135A extracts a plurality of candidate phrases from a title of the customer ticket. Next, application 135A vectorizes the plurality of candidate phrases. Also, application 135A identifies context data associated with the customer ticket, and application 135A vectorizes the context data. As used herein, the term “vectorize” may be defined as converting text into a numerical representation. When text is vectorized, words that have similar meanings will be converted to numbers that are relatively close in vector space, and words that have different meanings will be converted to numbers that are relatively far apart in the vector space. Vectorizing text may also be referred to as “embedding” or “word embedding”. In an example, text may be provided as an input to a neural network and the output of the neural network is a numerical representation of the text.

After text is vectorized (i.e., converted to a numerical representation), any of various machine learning algorithms may be applied to the vectorized text. In an example, a neural network may be applied to the vectorized text. In other examples, other types of machine learning algorithms may be applied to the vectorized text.

Then for each candidate phrase of the plurality of candidate phrases, application 135A calculates a similarity between a vectorized version of the respective candidate phrase and the vectorized context data. The similarity that is calculated for a given candidate phrase may be referred to as a given similarity score. After similarity scores have been calculated for all candidate phrases, the top N candidate phrases are selected based on having the highest similarity scores out of all of the candidate phrases, where N is a positive integer. The value of N may vary from embodiment to embodiment. After the top N candidate phrases have been selected, these top N candidate phrases may be provided as recommendations to one or more applications (e.g., application 135B) containing solutions which are processing the customer ticket and/or generating solution recommendations in response to the customer ticket. It is noted that the top N candidate phrases may also be referred to as the key phrases. Other actions may be taken as a result of the top N candidate phrases (i.e., key phrases) being selected, such as generating a listing of the key phrases in a graphical user interface (GUI), storing the key phrases in a database, associating (i.e., mapping, linking) the customer ticket with the key phrases, adding the key phrases to solution manuals and/or a knowledge base associated with the customer ticket to make the solution manuals and/or knowledge base easier to search, and/or other actions.

In an example, after the key phrases are provided as a recommendations to application 135B, application 135B may use the key phrases to search a knowledge base for descriptions, solutions, and examples that are relevant to the customer ticket. These key phrases may also be used by application 135B to identify a possible match in the solution corpus for the customer ticket. Other types of applications may use the key phrases provided by application 135A in other suitable manners.

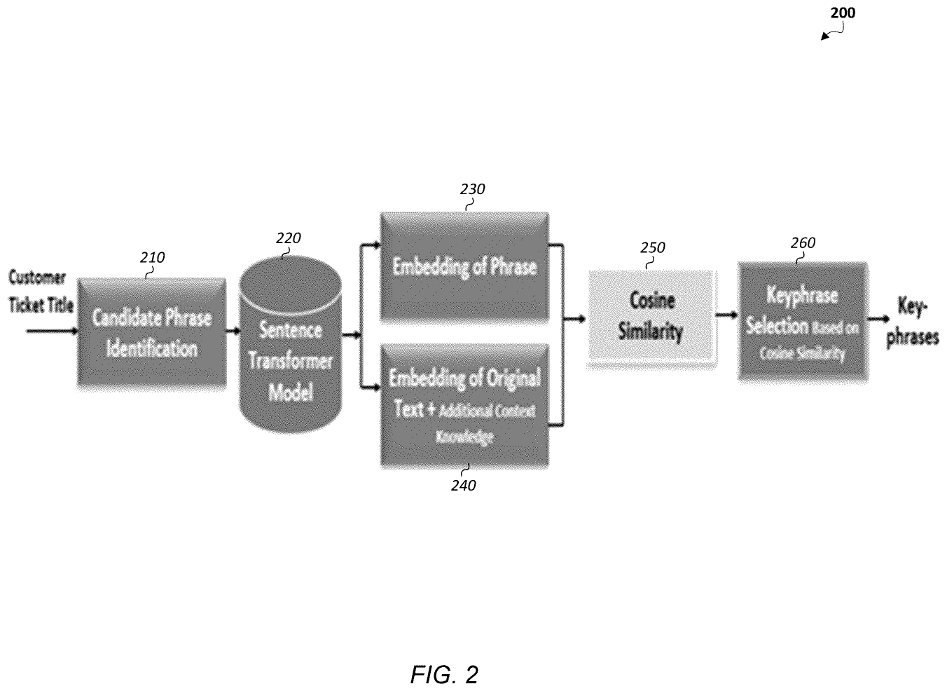

Turning now to FIG. 2, a logical block diagram of a two-step process 200 for extraction of keyphrases is shown, in accordance with one or more embodiments of the current subject matter. In a first stage 210 of the two-step process, extraction of candidate phrases is performed using a candidate phrase extraction method. In an example, the candidate phrase extraction method is a graph ranking method. In other examples, other types of candidate phrase extraction methods may be utilized. This first stage 210 is followed by a second stage, where the second stage involves the selection of keyphrases based on contextual similarity of the candidate phrase with the given context. In the case of a customer ticket being processed, the given context is the customer ticket description along with additional knowledge. The second stage may include the steps 220, 230, 240, 250, and 260 shown in FIG. 2.

In an example, pre-trained sentence transformers trained according to a sentence transformer model 220 may be utilized to find the embeddings of the extracted candidate phrase 230 and the embeddings of the original text along with additional context knowledge 240. The additional context knowledge 240 may be the customer ticket problem description, the solution title, the solution symptom, and/or other knowledge sources. For every candidate phrase, cosine similarity 250 may be calculated between the candidate phrase vector and the original text with additional content knowledge vector. The top phrases having the highest similarity are selected as the key phrases by keyphrase selection module 260.

It should be understood that the example of keyphrases being extracted from a customer ticket are merely illustrative of one particular embodiment. It should be understood that the keyphrase extraction methodologies presented herein can be used in a variety of scenarios with a variety of different inputs. While many of the keyphrase extraction methodology examples use a customer ticket as an example of an input being processed, these examples do not preclude the use of the keyphrase extraction methodologies with other types of inputs and in other types of scenarios.

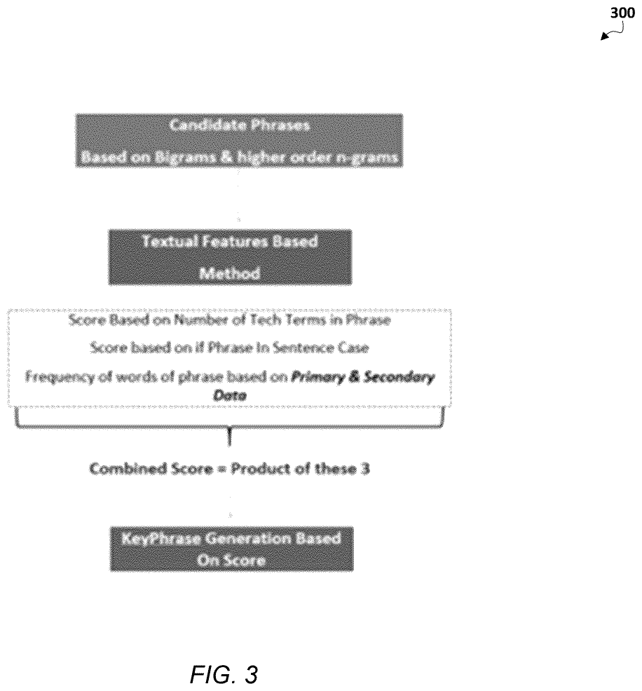

Referring now to FIG. 3, a diagram of a textual feature scoring-based method 300 is shown, in accordance with one or more embodiments of the current subject matter. At the beginning of the textual feature scoring-based method 300, candidate phrases are extracted from a received query, with the extraction from the original text of the received query based on bigrams and higher order n-grams. Next, scoring of the different candidate phrases is performed based on several factors including presence of technical terms in the phrase, if the phrase is capitalized (i.e., in sentence case), and frequency of words (of the phrase) in the original text and secondary text (e.g., customer ticket title and problem description). A secondary source of text (e.g., customer ticket problem description) along with the original text (e.g., title of the customer ticket) may be leveraged here to calculate the frequency of the words of the phrase to give higher weight to more important phrases. To detect the presence of technical terms in the phrase, a repository of technical terms may be queried to determine if any of the words in the phrase include technical terms. For example, the repository may include a listing of technical terms, and each word in the phrase may be used to search the listing to see if the word is considered to be a technical term.

In an example, a combined score is calculated for each phrase by generating a product of the three individual scores. The three individual scores are: (1) the score based on number of technical terms in the phrase, (2) the score based on if either the phrase is capitalized or if the first word in the phrase is capitalized, and (3) the score based on the frequency of words of the phrase based on the primary and secondary sources of data. In other examples, the combined score may be calculated for each phrase using other suitable techniques based on the three individual scores for the phrase. The top phrases based on the calculated score are considered as the key phrases from this method.

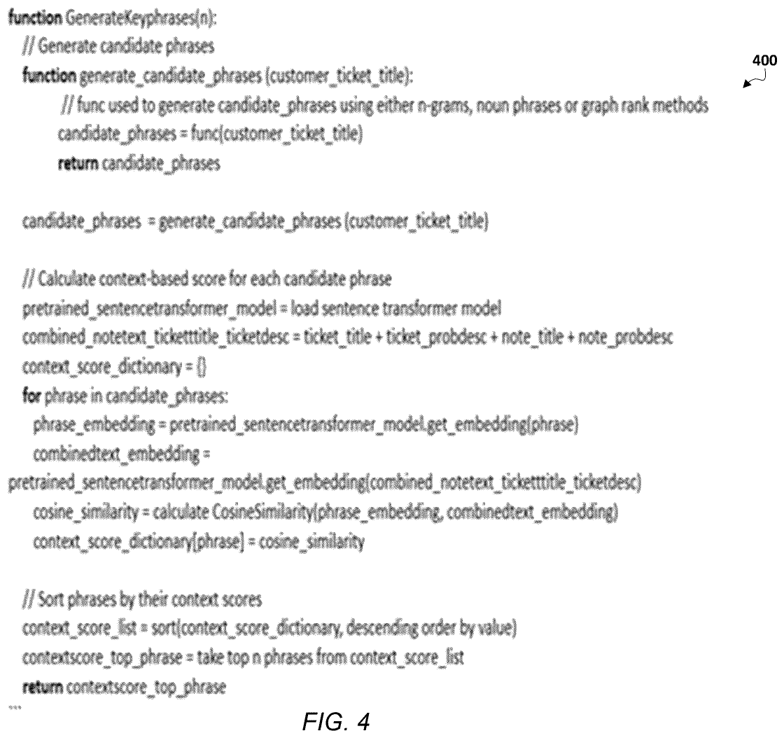

Turning now to FIG. 4, an example of pseudocode 400 for implementing the two-stage key phrase extraction methodology is shown, in accordance with one or more embodiments of the current subject matter. In an example, performance of the two-stage key phrase extraction methodology is initiated by calling the function Generatekeyphrases( ). This function may be called in response to receiving a textual input such as a customer ticket. The customer ticket may refer to a ticket generated by a customer in response to the customer having some issue or problem when trying to execute a software application, utilize a cloud service, or perform some other task associated with a service or application. In other examples, other types of textual inputs, besides customer tickets, may be received and cause the function Generatekeyphrases( ) to be invoked.

In the pseudocode 400, the line of code which includes “function generate_candidate_phrases (customer_ticket_title)” refers to a function which is used to generate candidate phrases using either n-grams, noun phrases, or graph rank methods. In an example, the candidate phrases are extracted from the customer ticket title. This function returns some number of candidate phrases which are extracted from the customer ticket title. The number of candidate phrases that are extracted may vary from embodiment to embodiment, and the number of candidate phrases that are extracted may vary depending on the number of words in the customer ticket title as well as on the specific words that are used in the customer ticket title. In the pseudocode 400, the line of code which reads “candidate_phrases=generate_candidate_phrases (customer_ticket_title)” calls the generate_candidate_phrases function to generate a plurality of candidate phrases based on the customer ticket title.

The next section of pseudocode 400 includes instructions for calculating the context-based score for each candidate phrase. The first line of code in this section reads “pretrained_sentencetransformer_model=load sentence transformer model” which loads a pretrained sentence transformer based on a sentence transformer model. In an example, the pretrained sentence transformer vectorizes input text to convert the input text into numbers in a number space. Any suitable pretrained sentence transformer trained according to any of various sentence transformer models may be utilized for vectorizing the input text.

The next line of code in this section reads “combined_notetext_tickettitle_ticketdesc=ticket_title+ticket_probdesc+note_title+note_probdesc”. This line of code combines the text of the ticket title, the ticket problem description, the solution title, and the solution problem description. It is noted that this line of code assumes that the textual input received by the two-stage key phrase extraction mechanism is a customer ticket. In other embodiments where other types of textual inputs are received by the two-stage key phrase extraction mechanism, this particular line of code may combine other fields of textual data to create a combined grouping of text which represents the context of the particular type of textual input.

The next line of code in the “calculate context-based score for each candidate phrase” section is a declaration of the context_score_dictionary function. Then, a for loop is initiated for each phrase of the plurality of candidate phrases extracted from the customer ticket title. Within the for loop body, the line “phrase_embedding=pretrained_sentencetransformer_model.get_embedding (phrase)” vectorizes the respective phrase and stores the vectorization in the variable “phrase_embedding”. Next, within the for loop, the line “combinedtext_embedding pretrained_sentencetransformer_model.get_embedding (combined_notetext_tickettitle_ticketdesc)” vectorizes the combined grouping of text, with the combined grouping of text being the context related to the customer ticket title. The vectorized version of the combined grouping of text is stored in the variable “combinedtext_embedding”.

Then, the next line within the for loop reads: “cosine_similarity=calculate CosineSimilarity(phrase_embedding, combinedtext_embedding)”. In other words, the cosine similarity between the vectorized version of the given candidate phrase and the vectorized version of the combined grouping of text is calculated. The next line within the for loop reads: “context_score_dictionary [phrase]=cosine_similarity”. This line stores the calculated cosine similarity in the array entitled “context_score_dictionary” for the given candidate phrase. This line marks the end of the for loop.

Next, the candidate phrases are sorted by their context score. For example, the line “context_score_list=sort (context_score_dictionary, descending order by value)” sorts the array of calculated cosine similarity scores in a descending order, and stores the ordered cosine similarity scores in the array named “context_score_list”. Then, the line “contextscore_top_phrase=take top n phrases from context_score_list” selects the top n candidate phrases according to their ordered cosine similarity scores. Finally, these top n candidate phrases are returned at the final line of pseudocode 400.

It should be appreciated that pseudocode 400 is merely one example of a list of instructions that may be executed and/or may be used as a template for generating a list of instructions to return a top N key phrases for customer tickets, where N is a positive integer, and where the value of N may vary from embodiment to embodiment. In other embodiments, other types of instructions in other suitable arrangements may be employed to execute a two-stage key phrase extraction methodology.

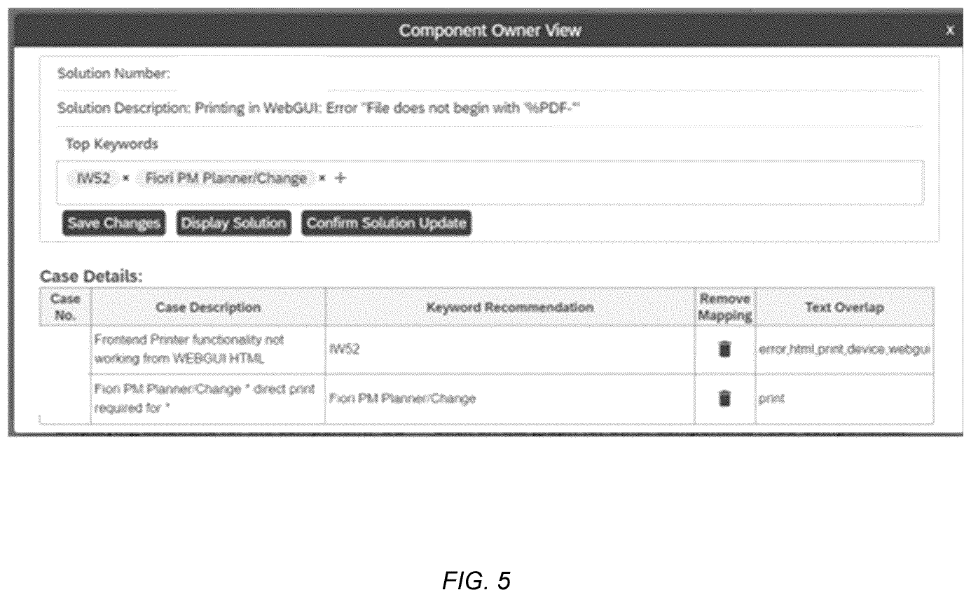

Referring now to FIG. 5, an example of a keyword extraction graphical user interface (GUI) is shown, in accordance with one or more embodiments of the current subject matter. The GUI of FIG. 5 gives an example of keywords generated for a given customer ticket. The keywords are extracted using the two-stage key phrase extraction methodology described in this document. In the example GUI of FIG. 5, the key phrase extracted is “Fiori PM Planner/Change”.

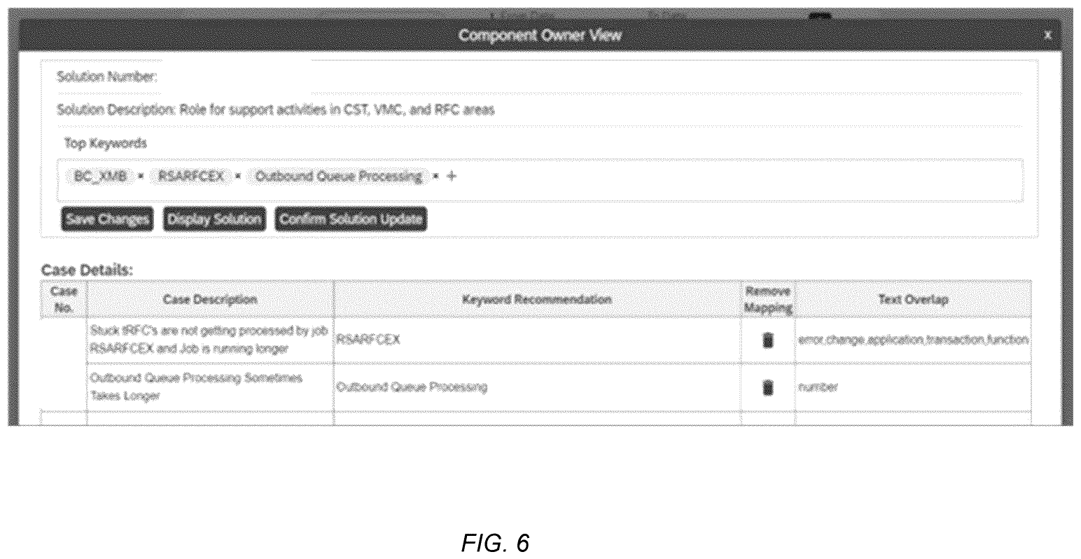

Turning now to FIG. 6, another example of a keyword extraction GUI is shown, in accordance with one or more embodiments of the current subject matter. The GUI of FIG. 6 gives an example of keywords generated for a particular customer ticket. The keywords are extracted using the two-stage key phrase extraction methodology described in this document. In the example GUI of FIG. 6, the key phrase extracted is “Outbound Queue Processing”.

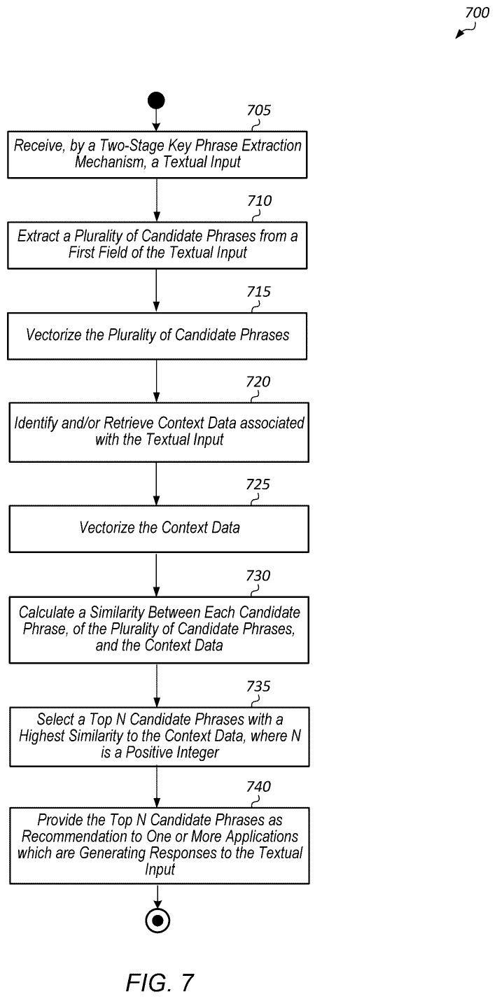

Referring now to FIG. 7, a process is depicted for employing a two-stage key phrase extraction methodology, in accordance with one or more embodiments of the current subject matter. A textual input is received by a two-stage key phrase extraction mechanism (block 705). The two-stage key phrase extraction mechanism may be a computing apparatus or a computing system. The apparatus or system may include one or more processors configured to execute a plurality of instructions. When executed, the plurality of instructions may cause the operations described in method 700. In an example, the textual input is a customer ticket. In other examples, the textual input is other types of inputs (e.g., email, search query, social media post, list).

In response to receiving the textual input, a plurality of candidate phrases are extracted from a first field of the textual input (block 710). In an example, the textual input is a customer ticket, and the first field is the title of the customer ticket. In another example, the textual input is an email, and the first field is the subject line of the email. In a further example, the textual input is a social media post, and the first field is the title or caption generated for the social media post. The social media post may also include other non-textual fields such as images and videos. In other examples, the textual input is other types of textual data inputs (e.g., search queries), and the first field may be other types of fields (e.g., search field) within the textual data input. Next, the plurality of candidate phrases are vectorized (block 715). As used herein, the term “vectorize” may be defined as converting words into a number space, where similar words are closer together in the number space and where dissimilar words are further apart in the number space.

Also, context data associated with the textual input is identified and/or retrieved (block 720). In an example, the context data is extracted from a second field of the textual input and from associated data relevant to the textual input. In an example, the second field is a description field of the customer ticket, and the associated data is a knowledge base (e.g., a solution manual) associated with the subject matter of the customer ticket. In some cases, the two-stage key phrase extraction mechanism may receive first and second inputs, with the first input being the customer ticket and the second input being solution information associated with the customer ticket. In these cases, the context data may be retrieved from the solution information. In another example, for a social media post that includes non-textual fields such as images or videos, the images and videos may be analyzed, and based on the analysis, other similar images or videos may be identified. These other similar images or videos may have associated text, and the associated text may be the second field. Alternatively, text may be generated based on the analysis of the images or videos, and the generated text may be the second field. Next, the context data is vectorized (block 725).

Then, a similarity in vector space between each candidate phrase, of the plurality of candidate phrases, and the context data is calculated (block 730). For example, for a first candidate phrase, a similarity between the first candidate phrase and the context in vector space is calculated. For a second candidate phrase, a similarity between the second candidate phrase and the context in vector space is calculated. For a third candidate phrase, a similarity between the third candidate phrase and the context in vector space is calculated, and so on. The similarity in vector space is calculated based on how close together each candidate phrase in vector space to the context, such that words that are closer together in vector space are deemed to be more similar than words that are further apart in vector space. In an example, a cosine similarity is calculated between the vectorized version of each candidate phrase and the vectorized version of the context. In other examples, other types of similarity calculations may be performed other than cosine similarity.

Then, a top N candidate phrases with a highest similarity to the context data are selected, where N is a positive integer (block 735). Next, the top N candidate phrases are provided as recommendations to one or more applications which are generating responses to the textual input (block 740). In an example, when the textual input is a customer ticket, the recommended top N candidate phrases are combined with the original customer ticket and incorporated in a solution manual for solving a problem identified in the original customer ticket. In another example, the recommended top N candidate phrases are provided to a search engine for searching a knowledge base to retrieve one or more potential solutions to problem(s) specified in the customer ticket. For other types of textual inputs, the recommended top N candidate phrases may be utilized by other applications and/or in other steps to generate an appropriate response to the textual input. For example, for textual inputs such as emails and social media posts, the recommended top N candidate phrases may be used to categorize the emails and/or social media posts, the recommended top N candidate phrases may be used to find similar emails and/or social media posts to the original email or social media post, the recommended top N candidate phrases may be used to determine how to process the emails and/or social media posts, and/or the recommended top N candidate phrases may be used to perform and/or influence other actions. After block 740, method 700 ends.

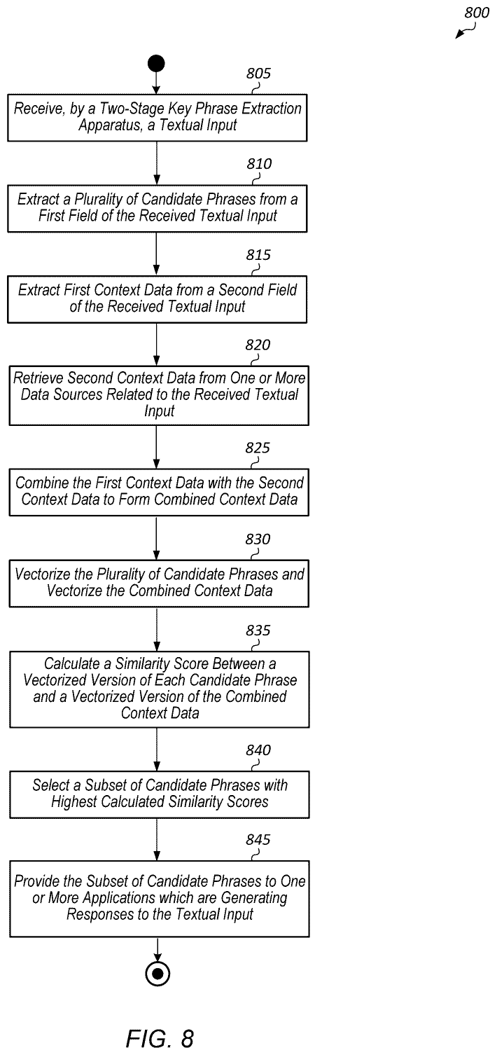

Turning now to FIG. 8, a process is depicted for employing a two-stage key phrase extraction methodology, in accordance with one or more embodiments of the current subject matter. A textual input is received by a two-stage key phrase extraction apparatus (block 805). Depending on the embodiment, the textual input may be a customer ticket, an email, a message, an excerpt from a web page, an excerpt from a book, an excerpt from another source, a search query, a social media post, a customer review, or other input. The textual input may be received in real-time, like for example, a newly created customer ticket or other newly created email or social media post. Alternatively, the textual input may be retrieved from a historical database. For example, the two-stage key phrase extraction apparatus may be employed to analyze and process a historical database of customer tickets, emails, social media posts, or the like.

The textual input may include one or more fields containing text, and the textual input may include non-textual data in addition to the text. Next, a plurality of candidate phrases are extracted from a first field of the received textual input (block 810). For example, if the textual input is a customer ticket, the first field may be the title of the customer ticket. Then, first context data is extracted from a second field of the received textual input (block 815). In an example, if the textual input is a customer ticket, the second field may be the description field of the customer ticket. If the received textual input only has one field, then block 815 may be skipped. Also, second context data is retrieved from one or more data sources related to the received textual input (block 820). In an example, the one or more data sources may include a knowledge base with potential answers to customer-related queries. Next, the first context data is combined with the second context data to form combined context data (block 825). Then, the plurality of candidate phrases are vectorized and the combined context data is vectorized (block 830).

Next, for each candidate phrase of the plurality of candidate phrases, a similarity score between a vectorized version of the candidate phrase and a vectorized version of the combined context data is calculated (block 835). In other words, a similarity between a vectorized version of the candidate phrase and a vectorized version of the combined context data is determined, and then a score is calculated based on the determined similarity. Then, a subset of candidate phrases are selected from the plurality of candidate phrases, where the subset of candidate phrases have highest calculated similarity scores of a plurality of calculated similarity scores corresponding to the plurality of candidate phrases (block 840). Next, the subset of candidate phrases are provided to one or more applications which are processing the textual input and/or generating responses to the textual input (block 845). In an example, the textual input is a block of text, and an application may be attempting to summarize the block of text or determine the most important elements or subject matter within the block of text. In this example, the application may utilize the subset of candidate phrases to assist in summarizing the block of text and/or determining the most important subject matter of the text. In another example, an application may be analyzing customer tickets over a period of time to determine most important trends and issues in customer problems. Other examples of applications processing the textual input and/or generating responses to the textual input are possible and are contemplated. After block 845, method 800 may end.

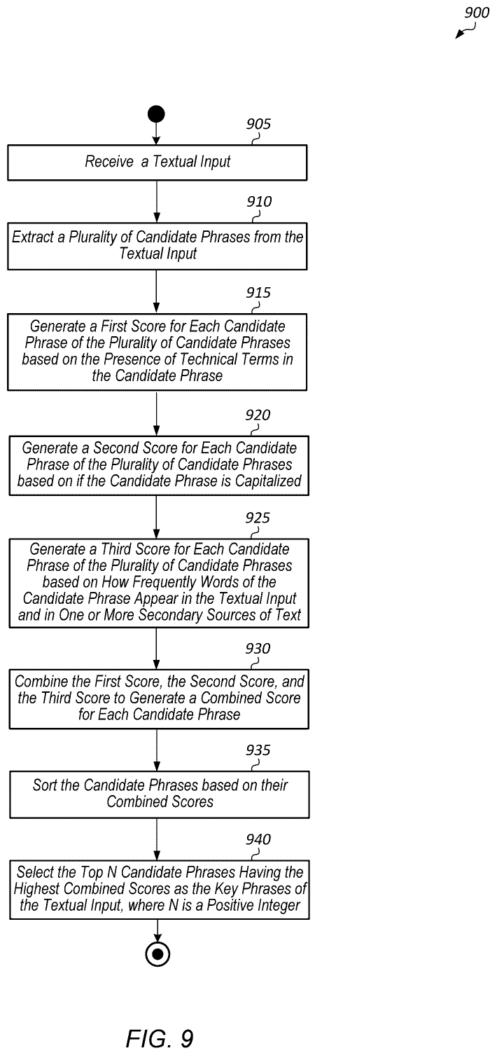

Referring now to FIG. 9, a process is depicted for employing textual feature scoring, in accordance with one or more embodiments of the current subject matter. A textual input is received by a textual feature scoring apparatus (block 905). The textual feature scoring apparatus may be any of the previously described components (e.g., cloud platform 130 of FIG. 1, application 135A of FIG. 1) or the textual feature scoring apparatus may be implemented as any suitable combination of hardware (e.g., circuitry, processing units, processing devices) and software (e.g., program instructions). Next, a plurality of candidate phrases are extracted from the textual input (block 910). In various examples, the extraction of the plurality of candidate phrases from the textual input may be based on bigrams and/or higher order n-grams. Any number (e.g., 3, 7, 10, 12, 20, 50, 100) of candidate phrases may be extracted from the textual input, with the number varying according to the embodiment and according to the textual input.

Then, a first score is generated for each candidate phrase of the plurality of candidate phrases based on the presence of technical terms in the candidate phrase (block 915). To detect the presence of technical terms in the candidate phrase, a repository of technical terms may be queried to determine if any of the words in the candidate phrase include technical terms. For example, the repository may include a listing of technical terms, and each word in the candidate phrase may be used to search the listing to see if the word is considered to be a technical term. In an example, the first score may be initialized to 1, and the first score may be incremented by 1 for each technical term in the candidate phrase. In other examples, the first score may be set to other values based on how many technical terms are included in the candidate phrase.

Next, a second score is generated for each candidate phrase of the plurality of candidate phrases based on if the candidate phrase is capitalized (i.e., in sentence case) (block 920). In an example, the second score may be set equal to 1 if the candidate phrase is capitalized, or the second score may be set equal to 0.5 if the candidate phrase is not capitalized. In another example, the second score may be set to 2 if each word in the candidate phrase is capitalized, the second score may be set to 1 if only the first word of the candidate phrase is capitalized, or the second score may be set to 0.5 if none of the words of the candidate phrase are capitalized. In other examples, the second score may be set to other values based on whether or not the candidate phrase is capitalized. In general, the second score will be higher if the candidate phrase is capitalized and lower if the candidate phrase is not capitalized.

Then, a third score is generated for each candidate phrase of the plurality of candidate phrases based on how frequently words of the candidate phrase appear in the textual input and in one or more secondary sources of text (block 925). In general, the more frequently words of the candidate phrase appear in the textual input and in the secondary source(s) of text, the higher the third score will be. In one embodiment, the third score is set equal to the number of times any word of the candidate phrase appears in the textual input and in any secondary source of text. In an example, when the textual input is a title of a customer ticket, the secondary source of text may be the customer ticket problem description. Generally speaking, the secondary source of text may be any text that is related to, associated with, and/or relevant to the original textual input. The textual feature scoring apparatus may utilize any of various criteria for determining which text to include in the secondary source(s) of text, with the criteria varying from embodiment to embodiment.

Next, the first score, the second score, and the third score are combined to generate a combined score for each candidate phrase (block 930). In an example, the combined score is calculated for each phrase by generating a product of the three individual scores. In other words, in this example, the combined score is equal to the first score multiplied by the second score multiplied by the third score. In another example, a weighted formula may be applied to the three individual scores to generate the combined score, with a different weight applied to each score. In other examples, the combined score may be generated based on other ways of combining the three individual scores.

Then, the candidate phrases are sorted based on their combined scores (block 935). In an example, a list of the candidate phrases may be sorted based on their combined scores with candidate phrases having the highest scores at the top of the list and with candidate phrases having the lowest scores at the bottom of the list. In other words, in this example, the list is sorted from highest combined score to lowest combined score. Next, the top N candidate phrases having the highest combined scores are selected as the key phrases of the textual input, where N is a positive integer, and where the value of N may vary from embodiment to embodiment (block 940). After block 940, method 900 may end.

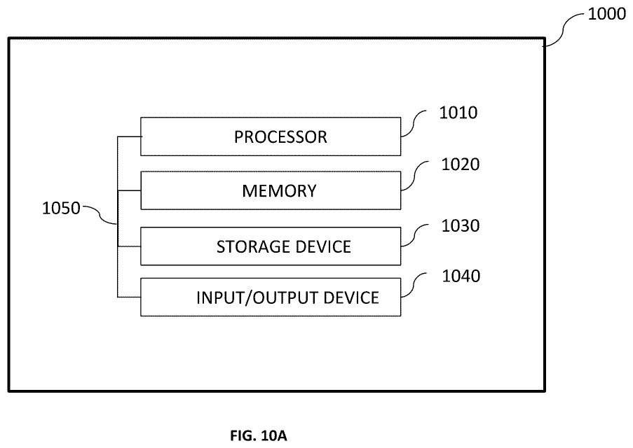

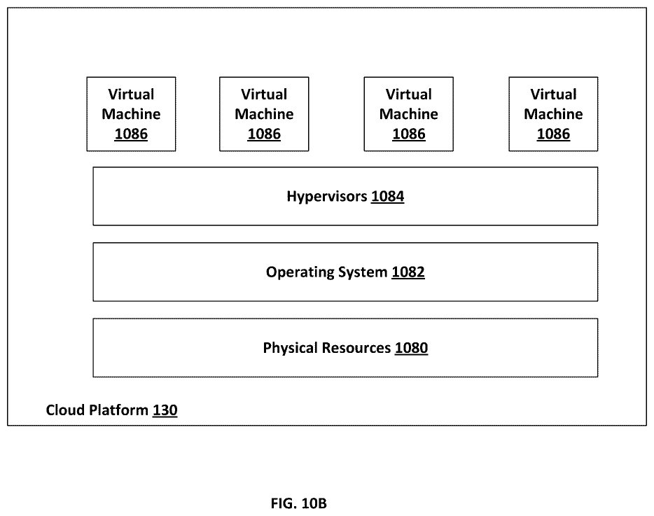

In some implementations, the current subject matter may be implemented in a system 1000 as shown in FIG. 10A. The system 1000 may include a processor 1010, a memory 1020, a storage device 1030, and an input/output device 1040. Each of the components 1010, 1020, 1030 and 1040 may be interconnected using a system bus 1050. The processor 1010 may be configured to process instructions for execution within the system 1000. In some implementations, the processor 1010 may be a single-threaded processor. In alternate implementations, the processor 1010 may be a multi-threaded processor. The processor 1010 may be further configured to process instructions stored in the memory 1020 or on the storage device 1030, including receiving or sending information through the input/output device 1040. The memory 1020 may store information within the system 1000. In some implementations, the memory 1020 may be a computer-readable medium. In alternate implementations, the memory 1020 may be a volatile memory unit. In yet some implementations, the memory 1020 may be a non-volatile memory unit. The storage device 1030 may be capable of providing mass storage for the system 1000. In some implementations, the storage device 1030 may be a computer-readable medium. In alternate implementations, the storage device 1030 may be a floppy disk device, a hard disk device, an optical disk device, a tape device, non-volatile solid state memory, or any other type of storage device. The input/output device 1040 may be configured to provide input/output operations for the system 1000. In some implementations, the input/output device 1040 may include a keyboard and/or pointing device. In alternate implementations, the input/output device 1040 may include a display unit for displaying graphical user interfaces.

FIG. 10B depicts an example implementation of the cloud platform 130 (of FIG. 1). The cloud platform 130 may be implemented using various physical resources 1080, such as at least one or more hardware servers, at least one storage, at least one memory, at least one network interface, and the like. The cloud platform 130 may also be implemented using infrastructure, as noted above, which may include at least one operating system 1082 for the physical resources 1080 and at least one hypervisor 1084 (which may create and run at least one virtual machine 1086). For example, each multitenant application may be run on a corresponding virtual machine 1086.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

Although ordinal numbers such as first, second and the like can, in some situations, relate to an order; as used in a document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include program instructions (i.e., machine instructions) for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives program instructions as a machine-readable signal. The term “machine-readable signal” refers to any signal used to provide machine instructions and/or data to a programmable processor. The machine-readable medium can store such program instructions non-transitorily, such as for example as would a non-transient solid state memory or a magnetic hard drive or any equivalent storage medium. The machine-readable medium can alternatively or additionally store such machine instructions in a transient manner, such as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising: at least one processor; and at least one memory storing instructions that, when executed by the at least one processor, cause operations comprising: extracting a plurality of candidate phrases from a first field of a received textual input; extracting first context data from a second field of the received textual input; retrieving second context data from one or more data sources related to the received textual input; combining the first context data and the second context data to form combined context data; vectorizing the plurality of candidate phrases and the combined context data; determining, for each candidate phrase of the plurality of candidate phrases, a similarity score between a vectorized version of the candidate phrase and a vectorized version of the combined context data; selecting a subset of candidate phrases from the plurality of candidate phrases, wherein the subset of candidate phrases have highest determined similarity scores of a plurality of determined similarity scores corresponding to the plurality of candidate phrases; and providing the subset of candidate phrases to one or more applications which are generating responses to the textual input.

Example 2: The system of Example 1, wherein the similarity score is calculated as a cosine similarity between the vectorized version of the candidate phrase and the vectorized version of the combined context data.

Example 3: The system of any of Examples 1-2, wherein the plurality of candidate phrases are extracted from the first field of the received textual input using a graph ranking method.

Example 4: The system of any of Examples 1-3, wherein the received textual input is a customer ticket.

Example 5: The system of any of Examples 1-4, wherein the first field is a title of the customer ticket.

Example 6: The system of any of Examples 1-5, wherein the second field is a problem description field of the customer ticket.

Example 7: The system of any of Examples 1-6, wherein extracting the plurality of candidate phrases from the first field of the received textual input comprises: extracting a plurality of potential candidate phrases from the first field of the received textual input; scoring each potential candidate phrase of the plurality of potential candidate phrases based at least on: a presence of technical terms in the potential candidate phrase, if the potential candidate phrase is capitalized, and a frequency of words of the potential candidate phrase in the first field of the received textual input, a second field of the received textual input, and one or more secondary data sources; and selecting a subset of the plurality of potential candidate phrases having highest scores out of the plurality of potential candidate phrases.

Example 8: The system of any of Examples 1-7, wherein the operations further comprise: generating a first score for each potential candidate phrase based on the presence of technical terms in the potential candidate phrase; generating a second score for each potential candidate phrase based on if the potential candidate phrase is capitalized; and generating a third score for each potential candidate phrase based on how frequently words of the potential candidate phrase appear in the received textual input and in the one or more data sources related to the received textual input.

Example 9: The system of any of Examples 1-8, wherein the operations further comprise combining the first score, the second score, and the third score to generate a combined score for each potential candidate phrase.

Example 10: The system of any of Examples 1-9, wherein the operations further comprise sorting the plurality of potential candidate phrases based on corresponding combined scores.

Example 11: The system of any of Examples 1-10, wherein the operations further comprise selecting one or more potential candidate phrases having highest combined scores as key phrases of the received textual input.

Example 12: A method comprising: extracting a plurality of candidate phrases from a first field of a received textual input; extracting first context data from a second field of the received textual input; retrieving second context data from one or more data sources related to the received textual input; combining the first context data and the second context data to form combined context data; vectorizing the plurality of candidate phrases and the combined context data; determining, for each candidate phrase of the plurality of candidate phrases, a similarity score between a vectorized version of the candidate phrase and a vectorized version of the combined context data; selecting a subset of candidate phrases from the plurality of candidate phrases, wherein the subset of candidate phrases have highest determined similarity scores of a plurality of determined similarity scores corresponding to the plurality of candidate phrases; and providing the subset of candidate phrases to one or more applications which are generating responses to the received textual input.

Example 13: The method of Example 12, wherein the similarity score is calculated as a cosine similarity between the vectorized version of the candidate phrase and the vectorized version of the combined context data.

Example 14: The method of any of Examples 12-13, wherein the plurality of candidate phrases are extracted from the first field of the received textual input using a graph ranking method.

Example 15: The method of any of Examples 12-14, wherein the received textual input is a customer ticket.

Example 16: The method of any of Examples 12-15, wherein the first field is a title of the customer ticket.

Example 17: The method of any of Examples 12-16, wherein the second field is a problem description field of the customer ticket.

Example 18: The method of any of Examples 12-17, wherein extracting the plurality of candidate phrases from the first field of the received textual input comprises: extracting a plurality of potential candidate phrases from the first field of the received textual input; scoring each potential candidate phrase of the plurality of potential candidate phrases based at least on: a presence of technical terms in the potential candidate phrase, if the potential candidate phrase is capitalized, and a frequency of words of the potential candidate phrase in the first field of the received textual input, a second field of the received textual input, and one or more secondary data sources; and selecting a subset of the plurality of potential candidate phrases based on those potential candidate phrases with highest scores of the plurality of potential candidate phrases.

Example 19: The method of any of Examples 12-18, the operations further comprise: generating a first score for each potential candidate phrase based on the presence of technical terms in the potential candidate phrase; generating a second score for each potential candidate phrase based on if the potential candidate phrase is capitalized; and generating a third score for each potential candidate phrase based on how frequently words of the potential candidate phrase appear in the received textual input and in the one or more data sources related to the received textual input.

Example 20: A non-transitory computer readable medium storing instructions, which when executed by at least one data processor, result in operations comprising: extracting a plurality of candidate phrases from a first field of a received textual input; extracting first context data from a second field of the received textual input; retrieving second context data from one or more data sources related to the received textual input; combining the first context data and the second context data to form combined context data; vectorizing the plurality of candidate phrases and the combined context data; determining, for each candidate phrase of the plurality of candidate phrases, a similarity score between a vectorized version of the candidate phrase and a vectorized version of the combined context data; selecting a subset of candidate phrases from the plurality of candidate phrases, wherein the subset of candidate phrases have highest determined similarity scores of a plurality of determined similarity scores corresponding to the plurality of candidate phrases; and providing the subset of candidate phrases to one or more applications which are generating responses to the received textual input.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

What is claimed:

1. A system comprising:
at least one processor; and
at least one memory storing instructions that, when executed by the at least one processor, cause operations comprising:
extracting a plurality of candidate phrases from a first field of a textual input;
extracting first context data from a second field of the textual input;
retrieving second context data from one or more data sources related to the textual input;
combining the first context data and the second context data to form combined context data;
vectorizing the plurality of candidate phrases and the combined context data;
determining, for each candidate phrase of the plurality of candidate phrases, a similarity score between a vectorized version of the candidate phrase and a vectorized version of the combined context data;
selecting a subset of candidate phrases from the plurality of candidate phrases, wherein the subset of candidate phrases have highest determined similarity scores of a plurality of determined similarity scores corresponding to the plurality of candidate phrases; and
providing the subset of candidate phrases to one or more applications which are generating responses to the textual input.

2. The system of claim 1, wherein the similarity score is calculated as a cosine similarity between the vectorized version of the candidate phrase and the vectorized version of the combined context data.

3. The system of claim 1, wherein the plurality of candidate phrases are extracted from the first field of the textual input using a graph ranking method.

4. The system of claim 1, wherein the textual input is a customer ticket.

5. The system of claim 4, wherein the first field is a title of the customer ticket.

6. The system of claim 5, wherein the second field is a problem description field of the customer ticket.

7. The system of claim 1, wherein extracting the plurality of candidate phrases from the first field of the textual input comprises:
extracting a plurality of potential candidate phrases from the first field of the textual input;
scoring each potential candidate phrase of the plurality of potential candidate phrases based at least on: a presence of technical terms in the potential candidate phrase, if the potential candidate phrase is capitalized, and a frequency of words of the potential candidate phrase in the first field of the textual input, a second field of the textual input, and one or more secondary data sources; and
selecting a subset of the plurality of potential candidate phrases having highest scores out of the plurality of potential candidate phrases.

8. The system of claim 7, wherein the operations further comprise:
generating a first score for each potential candidate phrase based on the presence of technical terms in the potential candidate phrase;
generating a second score for each potential candidate phrase based on if the potential candidate phrase is capitalized; and
generating a third score for each potential candidate phrase based on how frequently words of the potential candidate phrase appear in the textual input and in the one or more data sources related to the textual input.

9. The system of claim 8, wherein the operations further comprise combining the first score, the second score, and the third score to generate a combined score for each potential candidate phrase.

10. The system of claim 9, wherein the operations further comprise sorting the plurality of potential candidate phrases based on corresponding combined scores.

11. The system of claim 10, wherein the operations further comprise selecting one or more potential candidate phrases having highest combined scores as key phrases of the textual input.

12. A method comprising:
extracting a plurality of candidate phrases from a first field of a textual input;
extracting first context data from a second field of the textual input;
retrieving second context data from one or more data sources related to the textual input;
combining the first context data and the second context data to form combined context data;
vectorizing the plurality of candidate phrases and the combined context data;
determining, for each candidate phrase of the plurality of candidate phrases, a similarity score between a vectorized version of the candidate phrase and a vectorized version of the combined context data;
selecting a subset of candidate phrases from the plurality of candidate phrases, wherein the subset of candidate phrases have highest determined similarity scores of a plurality of determined similarity scores corresponding to the plurality of candidate phrases; and
providing the subset of candidate phrases to one or more applications which are generating responses to the textual input.

13. The method of claim 12, wherein the similarity score is calculated as a cosine similarity between the vectorized version of the candidate phrase and the vectorized version of the combined context data.

14. The method of claim 12, wherein the plurality of candidate phrases are extracted from the first field of the textual input using a graph ranking method.

15. The method of claim 12, wherein the textual input is a customer ticket.

16. The method of claim 15, wherein the first field is a title of the customer ticket.

17. The method of claim 16, wherein the second field is a problem description field of the customer ticket.

18. The method of claim 12, wherein extracting the plurality of candidate phrases from the first field of the textual input comprises:
extracting a plurality of potential candidate phrases from the first field of the textual input;
scoring each potential candidate phrase of the plurality of potential candidate phrases based at least on: a presence of technical terms in the potential candidate phrase, if the potential candidate phrase is capitalized, and a frequency of words of the potential candidate phrase in the first field of the textual input, a second field of the textual input, and one or more secondary data sources; and
selecting a subset of the plurality of potential candidate phrases based on those potential candidate phrases with highest scores of the plurality of potential candidate phrases.

19. The method of claim 12, the operations further comprise:
generating a first score for each potential candidate phrase based on the presence of technical terms in the potential candidate phrase;
generating a second score for each potential candidate phrase based on if the potential candidate phrase is capitalized; and
generating a third score for each potential candidate phrase based on how frequently words of the potential candidate phrase appear in the textual input and in the one or more data sources related to the textual input.

20. A non-transitory computer readable medium storing instructions, which when executed by at least one data processor, result in operations comprising:
extracting a plurality of candidate phrases from a first field of a textual input;
extracting first context data from a second field of the textual input;
retrieving second context data from one or more data sources related to the textual input;
combining the first context data and the second context data to form combined context data;
vectorizing the plurality of candidate phrases and the combined context data;
determining, for each candidate phrase of the plurality of candidate phrases, a similarity score between a vectorized version of the candidate phrase and a vectorized version of the combined context data;
selecting a subset of candidate phrases from the plurality of candidate phrases, wherein the subset of candidate phrases have highest determined similarity scores of a plurality of determined similarity scores corresponding to the plurality of candidate phrases; and
providing the subset of candidate phrases to one or more applications which are generating responses to the textual input.
